(19) United States
(12) Patent Application Publication
(10) Pub. No.: US 2017/0074664 A1
(43) Pub. Date: Mar. 16, 2017

(54) Underwater Inspection System Using An Autonomous Underwater Vehicle ("AUV") In Combination With A Laser Micro Bathymetry Unit (Triangulation Laser) and High Definition Camera

(71) Applicant: C&C Technologies, Inc., Lafayette, LA (US)

(72) Inventor: Jami Cheramie, Lafayette, LA (US)

(21) Appl. No.: 15/123,640

(22) PCT Filed: Mar. 3, 2015
(86) PCT No.: PCT/US15/18454

§ 371 Date: Sep. 4, 2016

Related U.S. Application Data
(60) Provisional application No. 61/948,258, filed on Mar. 5, 2014.

(51) Int. Cl. G01C 21/20; H04N 7/18; H04N 5/225; G01C 11/30; B63G 8/00

(52) U.S. Cl. CPC G01C 21/20; G01C 11/30; B63G 8/001; H04N 5/225; H04N 7/188; B63G 2008/004; H04N 2005/2255

(57) ABSTRACT

A system for inspecting underwater objects includes an untethered, autonomous underwater vehicle (AUV), having a laser micro bathymetry system, namely a triangulation laser system, and a high resolution digital camera carried on the AUV.

### CROSS REFERENCE TO RELATED APPLICATIONS

This non-provisional United States Patent Application claims priority to U.S. provisional patent application Ser. 61/948,258, filed 5 Mar. 2014, for all purposes. The disclosure of that provisional patent application is incorporated herein by reference, to the extent same is not inconsistent with the disclosure herein.

### BACKGROUND

Many objects are positioned underwater, in inland and offshore areas, in connection with a number of industries. Included are pipelines carrying gas and liquid flowstreams, offshore platforms for oil and gas exploration and production, floating production facilities, drilling rigs, etc. From time to time, these objects require inspection. For illustrative purposes only, the present invention will be described primarily in connection with underwater pipeline inspection, although the system can be used for underwater inspection of any object.

It is known to use tethered Remotely Operated Vehicles (“ROVs”) for inspection of underwater objects. The ROV is connected to a surface vessel by a tether, comprising a plurality of lines running to a surface support vessel, the lines providing a means for controlling the speed and direction of travel of the ROV, transmitting data from the ROV to the surface, including but not limited to real time video imaging, use of lasers for distance measurement, etc.

A key limitation to tethered ROVs, in particular for underwater pipeline inspection, is the speed at which the tethered ROV can move along the pipeline—typically on the order of ¼ knot. This is due in part to the drag arising from the tether, which must be pulled through the water column along with the ROV. In contrast, an untethered Autonomous Underwater Vehicle or AUV, particularly a “fast flying” AUV, is capable of much more rapid movement through the water—e.g. a speed of 4 knots, v. ¼ knot for a tethered ROV. It can be readily appreciated that a given length of pipeline can therefore be inspected in a fraction of the time, as compared to use of a tethered ROV. It is understood that Autonomous Underwater Vehicle or AUV, as used in this application, means an untethered underwater vehicle which has a propulsion system and the ability to carry and utilize a variety of on-board equipment to control speed, depth, and direction of travel of the AUV, as well as measure, monitor and record a variety of information about the underwater environment and underwater objects in its vicinity.

Various underwater sensors have been used in connection with pipeline inspection and inspection of other underwater objects. Certain forms of lasers are known and in use for underwater inspection, namely a “Time of Flight” laser. Time of flight lasers carry limitations in the level of detail of the data procured. It is also known to use cameras of different forms for taking still and video photography of pipelines and the like. Many cameras likewise are limited in the level of detail they can obtain.

There is a need for an underwater inspection system which can collect very detailed information regarding underwater structures and objects, for example (but not limited to) pipelines, including the position thereof with respect to the seafloor, whether or not the pipeline is properly positioned on the seafloor, whether there exist any issues associated with the pipeline itself (e.g. leaks) or the surrounding seafloor, etc. As used in this application, the terms “underwater structures” and “underwater objects” are used in a broad sense, to include any type of man-made or natural structures and objects, including the seafloor itself.

### BRIEF DESCRIPTION OF THE DRAWINGS

FIG. 1 is a simplified schematic showing an AUV chassis embodying the principles of the present invention, with various operating components of the AUV system of the present invention represented in block form.

FIG. 2 is a view of an AUV system embodying the principles of the present invention, traversing a section of underwater pipeline, and acquiring data regarding same.

### DESCRIPTION OF SOME OF THE PREFERRED EMBODIMENTS

The present invention comprises a system for inspection of underwater structures, that is capable of obtaining highly detailed information over a large area, for example a long pipeline length.

Key components of the system include:
an Autonomous Underwater Vehicle or AUV, carrying
a Laser Micro Bathymetry system (a triangulation laser system); and
a high resolution digital camera.

Additional appropriate sensors, digital processors, controls, and data storage and transmission capabilities comprise other aspects of the invention.

With reference to the drawings, various aspects of a presently preferred embodiment of the invention can be described.

### The AUV and Associated Components

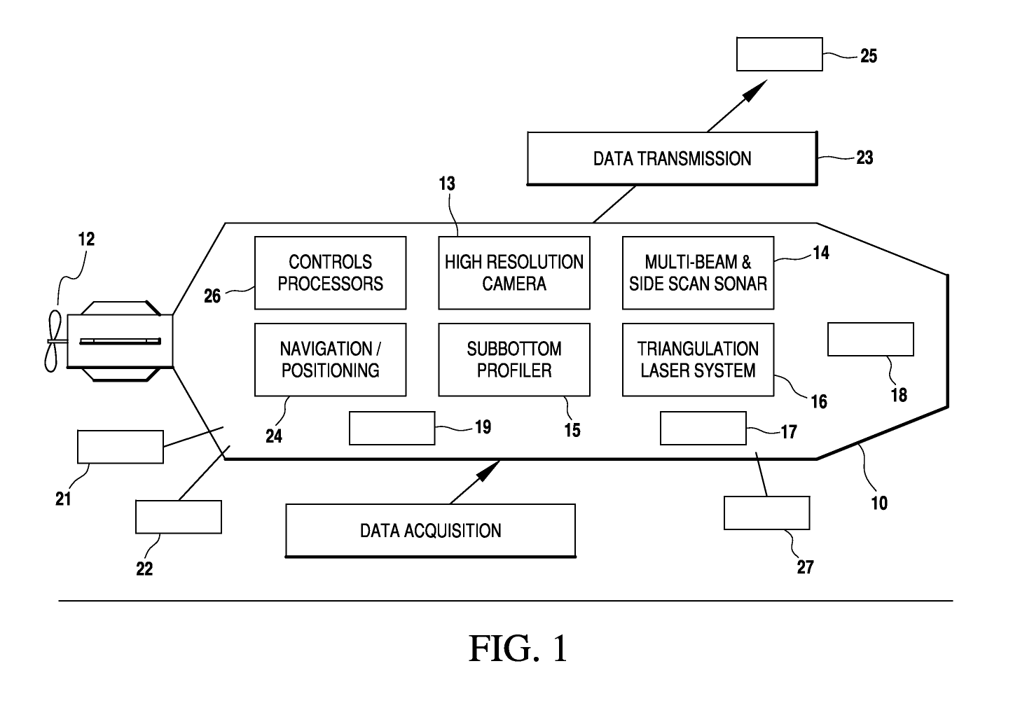

FIG. 1 shows, in simplified form, an AUV embodying the principles of an embodiment of the present invention. AUV 10 may comprise a commercially available autonomous underwater vehicle, such as Kongsberg Hugin 3000. It is understood that other commercially available AUVs are suitable and that the scope of the present invention is not confined to any particular AUV. Various sensors, etc. are represented in simplified block form in the drawing. It is understood that only some of the components of AUV 10 are depicted in FIG. 1, others of them being described later herein. As represented in the drawing, various data are collected by the AUV through the various sensors therein, and transmitted (by an acoustic or similar suitable communication system) to a surface location (e.g. support vessel). As is known in the art, AUVs carry a propulsion system, depicted by propeller 12, driven by one or more electric motors powered by various means, including but not limited to fuel cells or batteries.

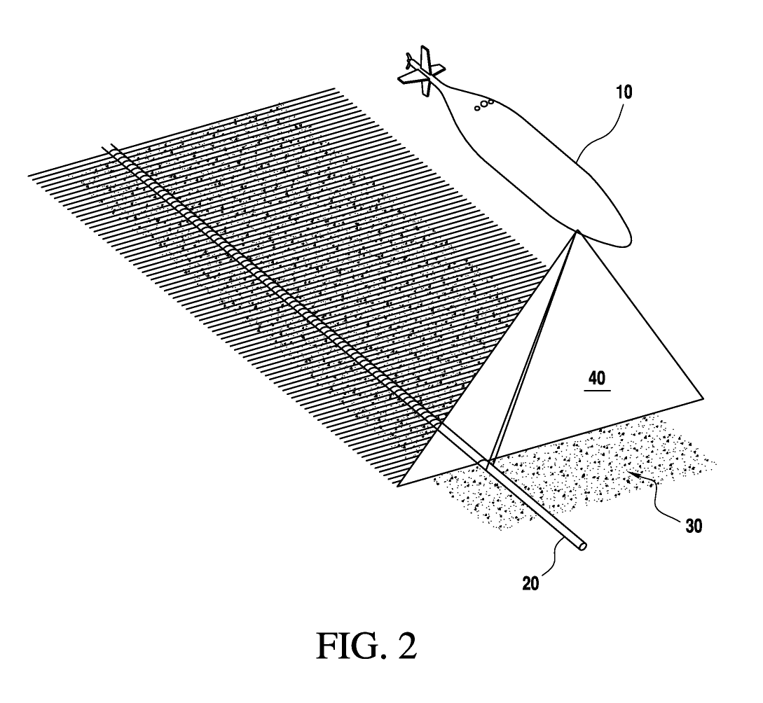

FIG. 2 illustrates AUV 10 in operation, conducting data acquisition by various sensors, for example microbathymetry readings by the use of a laser triangulation system. FIG. 2 shows an exemplary setting for use of the AUV of the present invention, in connection with inspection of a pipeline 20. Pipeline 20 traverses some distance on or in (or below the surface of) a seafloor 30. Pipeline 20 may have sections which are buried, or which are covered with protective materials. Other sections may be elevated above the seafloor due to changes in the pipeline elevation (due to expansion/contraction, etc.), and/or due to subsidence of the seafloor. The path traversed by pipeline 20, rather than a straight line between points, often, perhaps frequently, displays a number of bends, elevation changes, etc. Pipeline owners may wish to inspect pipelines for leakage and the like. All of these attributes may be detected by use of the present invention. It is understood that pipeline 20 is only an example of the type of underwater structure or object that can be inspected by the AUV system of the present invention; all forms of natural and man-made objects and structures can be inspected, including the seafloor itself.

As is known in the art, a triangulation laser system projects multiple laser beams at surfaces to be detected and measured, then uses appropriate detection apparatus (e.g. microprocessor(s)) and software to calculate positions, separation between objects, etc. Detection plane 40 illustrates an area being surveyed by the system, e.g. by the triangulation laser and/or other sensors; it is understood that same may in fact not be a simple plane but may be in multiple dimensions. In addition, a high resolution digital camera takes and stores photographic images at desired locations and at desired time intervals.

As is known in the art, a triangulation laser system uses one or more lasers to measure distances by detecting the angle at which a laser beam returns to a receiver, and from that angle measurement calculating a distance. In practice, a transmitter projects a laser beam or spot onto the object being measured. The laser beam (light) reflects from the object and strikes a receiver at a different position, defining an angle which is dependent on the distance between the transmitter and the receiver. The distance to the object or target is calculated from the position of the light on the receiver element, and from the distance between the transmitter and the receiver. Distances can be measured with an extremely high degree of precision, as compared to a time-of-flight or TOF laser measurement system. As is known in the relevant art, triangulation laser systems comprise a means for determining the angle between the transmitted and received laser beams and for calculating a distance to the object to the target, comprising one or more microprocessors, appropriate programming and software, etc.

To the knowledge of Applicant, a triangulation laser system has not previously been used in combination with the other system components in an AUV system, for pipeline surveying or other tasks, as herein described.

### Components of a Presently Preferred Embodiment of the AUV System

Various commercially available components may be used in combination in the AUV system of the present invention. While a number of makes and models of such components are available, and suitable for use in the AUV system, the following are examples:
The AUV 10 (the vehicle) comprising an element of the present invention is a non-tethered, “fast flying” type AUV, capable of underwater speeds on the order of 4 knots. Such AUVs permit inspection of (for example) long pipeline sections in a relatively short period of time. Various commercial embodiments of such AUVs are available. As previously noted, one presently known example believed suitable for use in the present invention is the Kongsberg Hugin 3000. AUVs of this type may be powered by an aluminum oxygen fuel cell or lithium ion polymer battery system, preferably providing at least 24-30 hours of operating time. Preferably, the AUV system of the present invention will have a depth rating of 3,000-4,500 meters, to permit work in deep ocean environments. As seen in FIG. 1, AUV 10 comprises a propulsion system typically including one or more propellers 12, driven by one or more electric motors, as previously described.
AUV launch/retrieval system and emergency recovery systems as needed, typically carried on a support vessel (not shown)
High resolution digital camera 13: a preferred camera to be used in conjunction with the AUV is one capable of flash illuminated black and white photographs of the underwater objects and seabed. Preferably, such camera has the capacity to take images at fixed intervals, at high resolution, e.g. 1360×1024 pixels. Photographs are taken at sufficient overlap, for example 30%, to permit generating high-resolution mosaics of underwater objects and the seafloor. Once commercially available camera, suitable for use in connection with the present invention, is the Prosilica GB 1380.
Multi-beam and side scan sonar systems 14: the AUV system preferably comprises both multibeam and side scan sonar systems. As is known in the art, the multibeam sonar has a primary function of determining water depths, by sonar time of travel principles. Various commercially available multibeam sonar systems are suitable, one suitable system being manufactured by Kongsberg, model Simrad EM 2040. The AUV system further preferably comprises a side scan sonar, to yield black and white images of the seafloor and related objects. Also operating on sonar principles, images can be generated based on the strength of the return sonar signals, generated at relatively high frequency, by principles known in the relevant art. One commercially available unit, suitable for use in the present invention, is the Edgetech Full Spectrum Chirp Side Scan Sonar, operating at 120/410 kHz.
Subbottom profiler 15: a relatively low-frequency sonar to penetrate seafloor sediments and yield strata information, an example being the Edgetech Full Spectrum Chirp Subbottom Profiler, operating at 1-6 kHz with a 6 element receiver array
Laser system 16 (triangulation laser system to yield microbathymetry information): one commercially available unit is the 2GRobotics model ULS-500. Preferably, the laser system has range resolution on the order of 4 mm, a swath coverage angle of approximately 50 degrees, approximately 1400 samples per swath, and 29 swaths per second with a maximum range of 10 meters.
Geo-chemical sensors 17: commercially available sensors capable of detecting substances such as methane, carbon dioxide, and hydrocarbons
Conductivity, temperature, and depth sensor 18, such as the Seabird Electronic SBE 49 FastCAT CTD with Digiquartz Depth Sensor A motion reference unit 19, for corrections to heave, pitch and roll, such as the IMU90 Motion Reference Unit
AUV velocity measurement apparatus 21 (velocity in multiple directions), such as the RDI Navigator DVL
A magnetometer 22, such as the Microtesla/MDM 63000-001
An acoustic communication system 23, to enable communication between the AUV and the support vessel while the AUV is deployed, and to generate positional data for AUV, such as the Kongsberg Simrad HiPAP Ultra Short Baseline USBL Acoustic Positioning System
Navigation and positioning equipment 24, including an AUV based navigation system; aided inertial navigation system; acoustic positioning, etc.
A means for real time display of data being acquired by the AUV system 25, to verify working status of system and assess quality of data, such as a Link Quest Acoustic Data Modem
Microprocessors and suitable programming and software, to operator sensors, process and collect data, and pilot the AUV, 26
Means to generate appropriate signals to guide the AUV along a pre-programmed path intended to follow the path of the pipeline, and preferably means to permit the AUV to detect and track the actual pipeline path, 27. Such means can adjust the navigation path based on data from multiple sensors, for example the laser, camera, photos, and multi-beam bathymetry sensors, which detect changes in the path of the pipeline and adjust the AUV course accordingly. The means can also support re-acquisition of the track of a buried pipeline, by use of the magnetometer, the laser, and the subbottom profiler to re-acquire the pipeline track once the pipeline re-emerges onto the sea floor
Appropriate microprocessors and software routines are used to operate the AUV, the laser micro bathymetry (triangulation laser) system, the proprietary camera system and related functionality, also represented by element 26.

### Method(s) of Use of the AUV System

The AUV of the present invention, comprising a Laser Micro Bathymetry system (a triangulation laser system) and a high resolution digital camera, may carry out various methods of inspecting and surveying of underwater structures, including but not limited to pipelines.

Accordingly, with reference to FIG. 2, one method of a presently preferred embodiment of the present invention, in connection with a pipeline inspection, by way of example only, comprises the steps of:

providing an AUV system, comprising an AUV, a laser micro bathymetry system, namely a triangulation laser system, and a high resolution digital camera;

defining a course of underwater travel relative to an underwater pipeline;

piloting the AUV along the defined course of underwater travel, in operative relationship to the pipeline;

with the triangulation laser system, acquiring data along at least a portion of the length of the pipeline, the data to include geographic position, elevation, and condition of the pipeline;

with the high resolution digital camera, acquiring photographic data along at least a portion of the length of the pipeline, the photographic data to include condition of the pipeline and location of nearby objects; and storing the triangulation laser system and high resolution photographic data and/or transmitting the data in real time to a receiver.

By way of example, pipeline inspection runs may comprise a single run generally tracking directly over the top of the pipeline, and/or runs on either side of the pipeline. Runs on the sides of the pipeline permit increased inspection capability and measurement of pipeline elevations and positioning with respect to the seafloor. Pipeline surveys may preferably be run at altitudes of 4 to 8 meters above the pipeline, which permit a broad sweep of the laser microbathymetry system and relatively wide angle photographs. It is to be understood that pipeline surveying is described by way of example only; the apparatus and method of the present invention may be used for underwater inspection/surveying of any underwater objects, or of the seafloor alone.

In the method(s) of the present invention, the AUV may be programmed, with hardware and software known in the art, to track a pre-programmed path, intended to follow the path of the pipeline. Alternatively, and in other embodiments, detection sensors and control apparatus may be employed to permit the AUV to detect and track the actual pipeline path. The AUV system of the present invention can make adjustments to the AUV navigation path based on data from the triangulation laser, high resolution photographs, and the multi-beam bathymetry unit. In addition, in situations in which the pipeline or other object being surveyed is under the seafloor (whether by installation in that manner, or later subsidence or covering of the object due to environmental forces), the AUV system can re-acquire the location of the buried pipeline (for example), using the magnetometer, triangulation laser, and subbottom profiler, in particular at the point in which the pipeline emerges onto the seafloor. In essence, the AUV system has a search function to locate buried objects such as pipelines.

Attributes of the system include:
the ability to achieve much higher underwater inspection speed with an untethered “fast flying” AUV, versus a tethered ROV (c. 4 knot v. ¼ knot), thereby decreasing time of inspection;
the triangulation laser system (micro bathymetry) yielding much more detailed information of both the pipeline and surrounding seafloor, providing advantages over a Time of Flight laser system;
the ability of the AUV to “fly” at a height above the pipeline of c. 8 meters, yielding a much larger viewing angle; and
the high definition digital camera yielding very detailed photographic images of the pipeline and surrounding seafloor, permitting a plurality of still photos to be combined into mosaic views of the pipeline and surroundings.

As noted, the above example directed toward pipeline inspection is only one of many different types of underwater inspection that may be carried out. Those having skill in the relevant art will understand that similar methods may be used to inspect expanses of the seafloor, for oceanographic and similar studies; structures such as platforms, subsea production facilities, drilling risers and the like, all used in connection with offshore oil and gas exploration and production; and a number of other types of underwater objects and structures.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof. For example, the system may be used in connection with many different forms of AUVs; additional sensing/measurement devices may be carried by the AUV, in addition to those described above; etc.

Therefore, the scope of the invention is to be determined not by the illustrative examples set forth above, but by the appended claims and their legal equivalents.

I claim:

1. A system for inspecting underwater objects, comprising:
an autonomous underwater vehicle;
said autonomous underwater vehicle further comprising a laser micro bathymetry system and a high resolution digital camera.

2. The system of claim 1, wherein said laser micro bathymetry system comprises a triangulation laser system, said triangulation laser system comprising a transmitter adapted to project a laser onto a target, a receiver adapted to receive a returned laser signal, and a means for detecting and determining an angle between said projected and returned laser and for determining a distance between said autonomous underwater vehicle and said target.

3. The system of claim 2, further comprising a multi-beam sonar and a side scan sonar.

4. The system of claim 3, further comprising an acoustic communication system.

5. The system of claim 4, further comprising a navigation system.

6. The system of claim 5, further comprising a means for guiding said autonomous underwater vehicle along a desired underwater path.

7. The system of claim 6, further comprising:
a geochemical sensor;
a motion reference unit;
conductivity, temperature, and depth sensors;
a velocity measurement unit; and
a magnetometer.

8. The system of claim 7, further comprising a microprocessor and a means for data display.

9. A system for inspecting underwater objects, comprising:
a) an autonomous underwater vehicle comprising a propulsion system and an acoustic communication system for acoustically communicating with a support vessel;
b) a triangulation laser system, said triangulation laser system carried by said autonomous underwater vehicle and comprising a transmitter adapted to project a laser onto a target, a receiver adapted to receive a returned laser signal, and a means for detecting and determining an angle between said projected and returned laser and for determining a distance between said autonomous underwater vehicle and said target, based on said angle;
c) said autonomous underwater vehicle further comprising a high resolution digital camera, a multi-beam sonar and side scan sonar, a navigation system, a means for guiding said autonomous underwater vehicle along a desired underwater path, a microprocessor for receiving and processing data, and a means for displaying said data.

10. The system of claim 9, further comprising:
a) a multi-beam sonar and a side scan sonar;
b) a geochemical sensor;
c) a motion reference unit;
d) conductivity, temperature, and depth sensors;
e) a velocity measurement unit; and
f) a magnetometer.

11. A method of inspecting underwater objects, comprising the steps of:
a) providing an autonomous underwater vehicle (AUV) system, comprising an AUV, a triangulation laser system, and a high resolution digital camera;
b) defining a course of underwater travel relative to an underwater object;
c) piloting the AUV along the defined course of underwater travel, in operative relationship to said underwater object;
d) with the triangulation laser system, acquiring data over at least a portion of said underwater object, the data to include geographic position, elevation, and condition of said underwater object;
e) with the high resolution digital camera, acquiring photographic data along at least a portion of said underwater object, said photographic data to include condition of said underwater object; and
f) storing the triangulation laser system and high resolution photographic data and/or transmitting the data in real time to a receiver.

13. The method of claim 12, further comprising the steps of:
g) receiving said data in step (f) via acoustic communication means by a support vessel;
h) analyzing said data; and
I) adjusting a route of travel of said AUV based on said data.
